(19) United States
(12) Patent Application Publication
(10) Pub. No.: US 2026/0159370 A1
(43) Pub. Date: Jun. 11, 2026

(54) FUEL HEAD ADAPTER FOR HYDRAULIC FRACTURING

(71) Applicant: Daniel Bennett, Sayre, OK (US)

(72) Inventor: Daniel Bennett, Sayre, OK (US)

(21) Appl. No.: 19/415,026

(22) Filed: Dec. 10, 2025

Related U.S. Application Data
(60) Provisional application No. 63/730,543, filed on Dec. 11, 2024.

(51) Int. Cl. B67D 7/04; B67D 7/46; E21B 43/26

(52) U.S. Cl. CPC B67D 7/04; B67D 7/465; E21B 43/2607

(57) ABSTRACT

A fuel head adapter for connecting a fuel head assembly to a fuel tank during high-volume fueling operations, such as hydraulic fracturing. The adapter includes a body with a flow passage configured to interface with a fuel head assembly. A sealing assembly disposed within the body comprises a resilient seal member and a plurality of springs configured to bias the seal member to form a fluid-tight seal against the filler tube of the fuel tank. The adapter also includes a quick-lock mechanism having a plurality of locking pins. The pins are configured to detachably and securely engage corresponding lugs or attachment features on the filler tube with a partial rotation. When the adapter is locked, the sealing assembly is compressed to ensure a leakproof connection, facilitating safe, automated, continuous fueling of equipment engines.

### CROSS-REFERENCE TO RELATED APPLICATIONS

This application claims the benefit of U.S. Provisional Application No. 63/730,543, filed Dec. 11, 2024, which is hereby incorporated herein by reference in its entirety.

### BACKGROUND

Hydraulic fracturing is a widely utilized and routine operation within the petroleum industry for enhancing the recovery and production of oil and natural gas from subterranean formations. This process involves injecting a fracturing fluid through a wellbore and into the formation at a pressure and flow rate sufficient to overcome the overburden stress and initiate a fracture within the reservoir rock. The fracturing fluid may comprise a water-based liquid, an oil-based liquid, a liquefied gas such as carbon dioxide, a dry gas such as nitrogen, or a combination thereof.

A crucial step in the hydraulic fracturing process is the introduction of proppant into the fracturing fluid. The proppant is transported into the fracture, where it remains after the injection pressure is released, thereby preventing the fracture from closing. This action creates a high-permeability channel that facilitates the flow of hydrocarbons (oil or gas) from the formation to the wellbore. Commonly used proppants include sand (e.g., 20/40 mesh), ceramics, and various synthetic materials.

Hydraulic fracturing operations require a significant array of high-power equipment, including multiple blending units to mix the fracturing fluid and numerous high-pressure pumping units to inject it into the wellbore. Each piece of this equipment is typically driven by an independent high-horsepower engine, often a diesel engine. Once the fracturing process is initiated, it must be continued uninterrupted for an extended period. Any cessation of the injection can cause the fracture to prematurely close, potentially necessitating the expensive and time-consuming repetition of the entire process.

Because the fracturing operation is continuous and long-lasting, the high-horsepower engines consume substantial fuel, requiring refueling while the equipment remains in operation. Historically, refueling involved manually discharging fuel from a source into each engine's fuel tank sequentially. More recently, the fueling process has been automated, with fuel automatically released from a source, such as a bulk storage tank or truck, to the equipment's fuel tanks when the fuel level reaches a predetermined minimum.

While the automation of the fueling process provides efficiency benefits, it introduces significant risks, primarily related to fuel leaks. The operational environment is often harsh, and failure to adequately seal and monitor the fuel hoses and, critically, the connection points to the fuel tanks, can lead to dangerous situations, including fire hazards or forced operational shutdowns. One of the most common and prominent points of fuel leakage is the connection interface where the fuel hose adapter connects to the engine's fuel tank inlet.

The lack of standardization across equipment manufacturers exacerbates the challenge in securing a reliable, leak-proof connection. Different brands of fuel tanks employ distinct designs for their fuel inlets. Although most inlets are cylindrical, they use different attachment mechanisms. For example, some fuel inlets use a threaded design to secure a fuel cap, while others employ a bayonet-type push-and-twist mechanism that uses lugs, tabs, or pins along the circumference to engage with the cap. Furthermore, the internal dimensions and sealing components (e.g., spring-loaded seals) can vary widely. This disparity in fuel inlet designs prevents the use of a universal fueling adapter.

Therefore, there exists an unmet need in the art for an improved, versatile, and reliable sealing fueling head adapter that can efficiently and safely interface with various non-standardized fuel tank inlets during continuous operations, thereby mitigating the risk of fuel leaks and allowing for uninterrupted hydraulic fracturing. The inventive concepts disclosed herein are directed to such an improved fueling head adapter.

### BRIEF DESCRIPTION OF THE DRAWINGS

FIG. 1 is a partial diagrammatic perspective view of an exemplary fuel head assembly connected to a fuel tank with a fuel head adapter constructed in accordance with the inventive concepts disclosed herein.

FIG. 2 is an enlarged perspective view of the exemplary fuel head assembly of FIG. 1.

FIG. 3 is a perspective view of a fuel head body of the fuel head assembly.

FIG. 4 is a top plan view of the fuel head body.

FIG. 5 is a bottom plan view of the fuel head body.

FIG. 6 is a sectional view taken along line 6-6 of FIG. 3.

FIG. 7 is a perspective view of a fuel inlet of the fuel tank of FIG. 1.

FIG. 8 is a perspective view of the fuel head adapter.

FIG. 9 is a sectional view taken along line 9-9 of FIG. 8.

FIG. 10 is a bottom plan view of the fuel head adapter.

FIG. 11 is a perspective view of the fuel head adapter connected to the fuel tank.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or of being practiced or carried out in various ways. Also, it is to be understood that the phraseology and terminology employed herein are for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” and any variations thereof are intended to cover a non-exclusive inclusion. For example, a process, method, article, or apparatus that comprises a list of elements is not necessarily limited to only those elements and may include other elements not expressly listed or inherently present therein.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, the use of the “a” or “an” is employed to describe elements and components of the embodiments disclosed herein. This is done merely for convenience and to give a general sense of the inventive concepts. This description should be read to include one or at least one, and the singular also includes the plural unless it is obvious that it is meant otherwise.

As used herein, qualifiers like “substantially,” “about,” “approximately,” and combinations and variations thereof are intended to include not only the exact amount or value that they qualify but also some slight deviations therefrom, which may be due to manufacturing tolerances, measurement error, wear and tear, stresses exerted on various parts, and combinations thereof, for example.

Finally, as used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The disclosed subject matter relates to an improved system and method for delivering fuel to heavy equipment, such as pumps and blenders, used in continuous industrial operations, specifically hydraulic fracturing. The system is designed to maintain fuel levels across multiple engine fuel tanks while the equipment is running.

Referring initially to the overall system, the fuel delivery system is typically operated from a control center, which may be housed in a portable trailer. The system includes a fuel supply stored in one or more portable storage tanks. A pump is operably connected to the fuel supply for discharging fuel, which is then directed to a manifold. The manifold is configured to distribute the fuel through individual hoses to the fuel tank of each piece of equipment. Valves are installed within the manifold to control the fuel flow and permit the independent operation or isolation of each hose.

On the equipment side, the hose connects to a fuel head assembly that interfaces with the engine's fuel tank inlet. The inventive concepts herein are primarily directed to a novel fuel head adapter that reliably connects the fuel head assembly to various non-standardized fuel tank inlets.

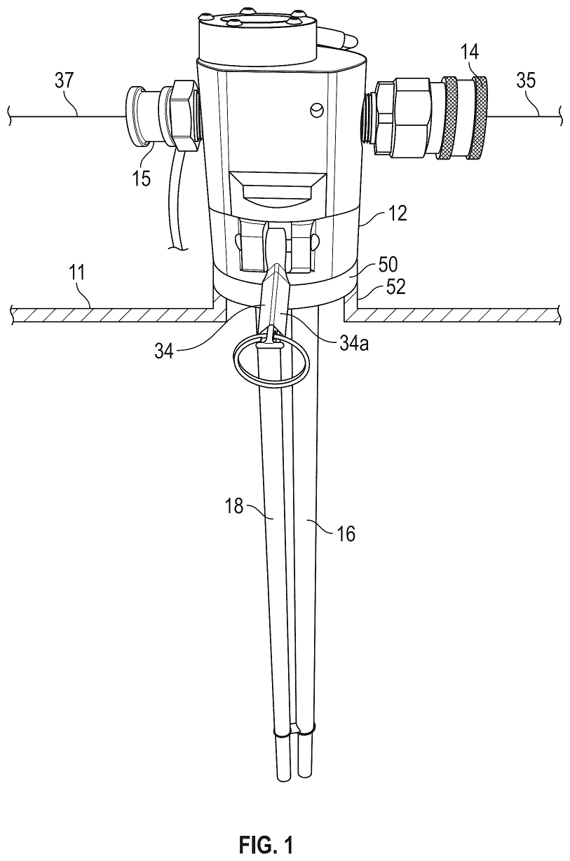

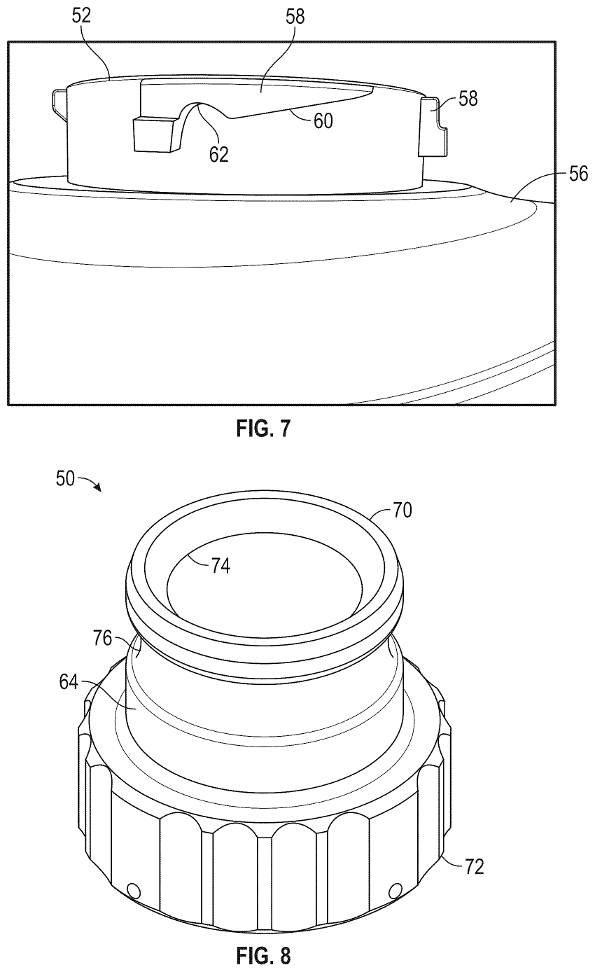

Referring now to the drawings, and more particularly to FIG. 1, an exemplary fuel head assembly 10 is secured to a fuel tank 11 via a fuel head adapter 50. As shown in FIG. 7, the fuel tank 11 is of the type that has a fuel inlet defined by a filler tube 52 with engaging structures, such as lugs or tabs 54, used with a push-and-twist cap mechanism that relies on pins located along the inner circumference of the cap. These pins engage with the lugs or tabs 54 on the filler tube 52.

The fuel head assembly 10 may include a fuel head body 12, an inlet connector 14, an overflow connector 15, an inlet tube 16, and a fuel level sensor 18. The fuel head body 12 includes an outer side 19, an upper end 20, and a lower end 22. The upper end 20 of the fuel head body 12 has an inlet port 24, a sensor port 26, an overflow port 28, and a vent port 30. The inlet port 24 is configured at an upstream end 31 to mate with the inlet connector 14 and at a downstream end 33 to mate with the inlet tube 16. The inlet connector 14 permits a quick connection to a hose 35 for fluid connection to the fuel source (not shown). The upstream end 31 of the inlet port 24 intersects the outer side 19 and may be oriented at a 90-degree angle relative to the downstream end 33, which intersects the female portion 29. Also, the diameter of the upstream end 31 may be greater than that of the downstream end 33 sufficiently to create backpressure as the fuel flows through the fuel head body 12. For example, the upstream end 31 may have a diameter of ¾ inches, and the downstream end 33 may have a diameter of ⅝ inches.

The inlet tube 16 may have a sufficient length to extend near the bottom of the fuel tank to allow for bottom-to-top filling. An upper end of the inlet tube 16 is secured to the fuel head body 12, in fluid communication with the inlet port 24.

The sensor port 26 is configured to receive the fuel level sensor 18. The fuel level sensor 18 may be any suitable fluid sensor, such as an optic sensor, a float sensor, a vibrating level switch, or a pressure transducer. The fuel level sensor 18 communicates with the trailer's control center via a wireless or wired communication channel.

The overflow port 28 intersects the lower end 22 and the outer side 19, where it is configured to mate with the overflow connector 14. The overflow connector 14 permits a quick connection to a hose 37 for fluid connection to a container (not shown) to capture any overfill.

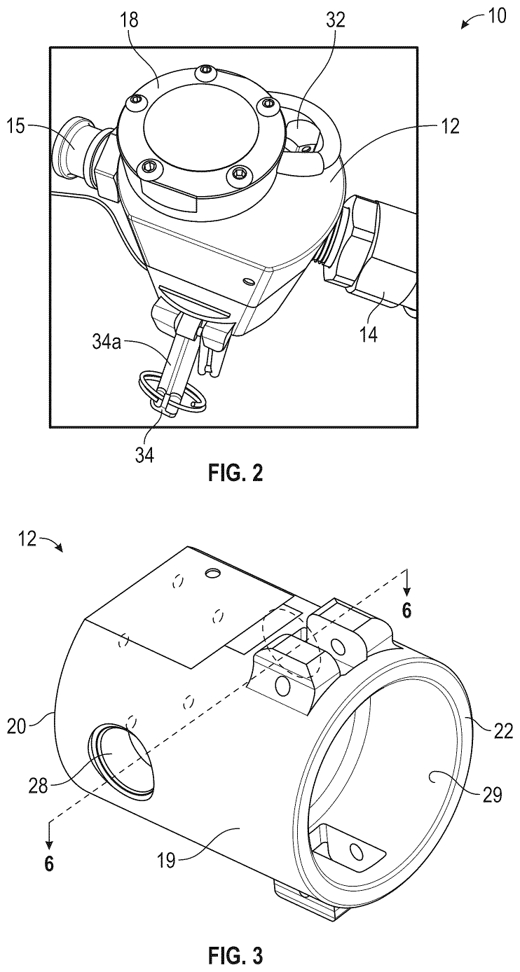

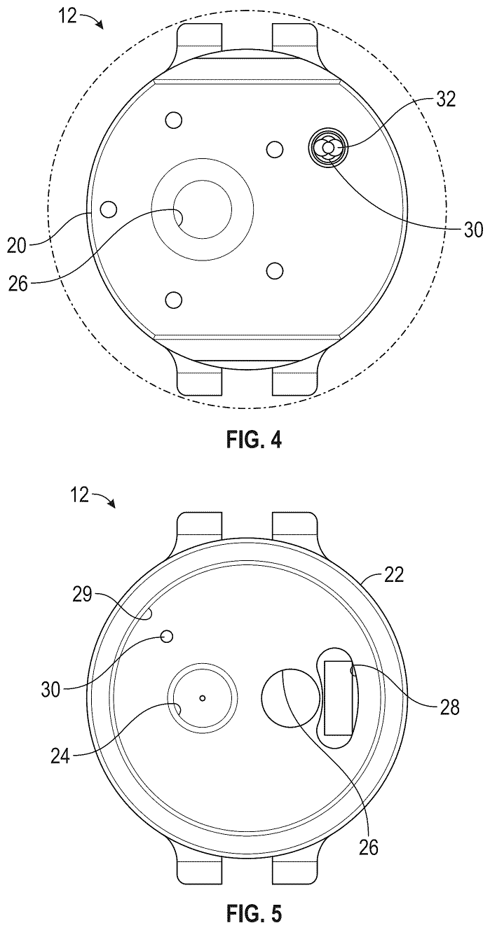

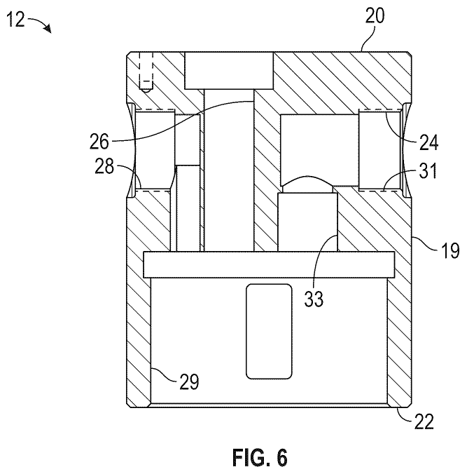

The vent port 30 intersects the lower end 22 and the outer side 19 and is configured to receive a check valve 32 (FIG. 2), so the vent port 30 functions to vent air and vapor from the fuel tank 11 while the fuel tank 11 is being filled with fuel. The check valve 32 prevents fuel from spilling through the vent port 28 during filling of the fuel tank 11.

The lower end 22 of the fuel head body 12 is configured as a female portion 29 to mate with the fuel head adapter 50. The adapter 50 is interposed between the fuel head body 12 and the inlet 52 of the fuel tank 11. A quick connect 34 (FIGS. 1 and 2) may be associated with the fuel head body 12 to join the fuel head body 12 to the adapter 50, which provides a corresponding male connector portion. The quick connect 34 may include a pair of cam arms 34a (only one cam arm 34a being visible) pivotally connected to the fuel head body 12.

Referring to FIG. 7, the fuel tank 11 has a filler tube 52 that extends into the interior of the tank 11, and an apron 56 that extends around the filler tube 52. The filler tube 52 has a plurality of lugs 58 positioned on an outer surface near the opening of the filler tube 52. There may be 2 to 4 lugs evenly spaced around the circumference. The lugs 58 have sloped surfaces 60 that guide the fuel head adapter 50 into place during securement. Each of the lugs 58 has a catch or notch 62 that provides a locking point for adapter 50 once it is fully rotated into place. The notches 62 securely hold the adapter 50, preventing accidental loosening.

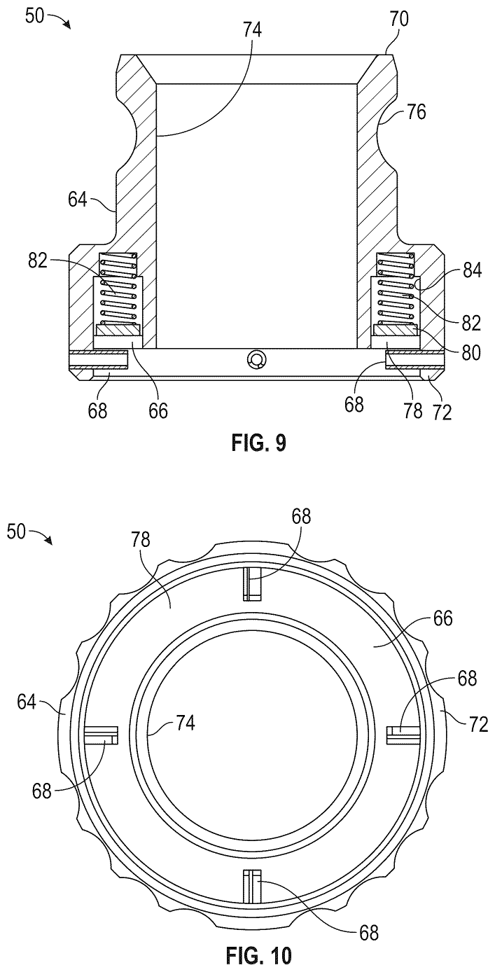

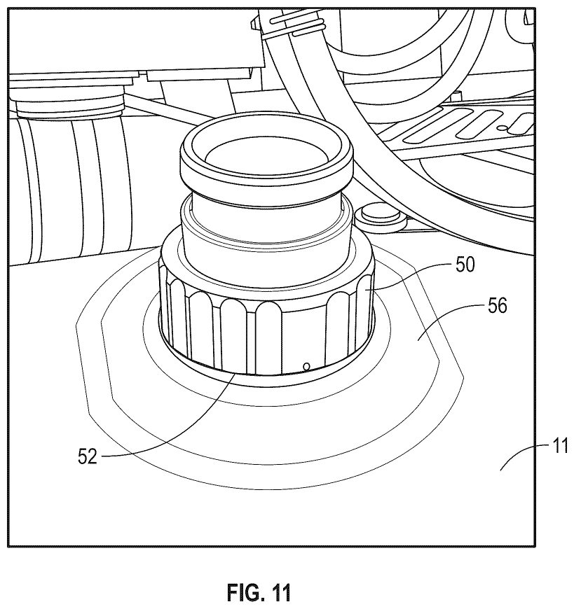

Referring now to FIGS. 8-10, the fuel head adapter 50 includes a body 64, a sealing assembly 66, and a plurality of locking pins 68.

The body 64 features an upper end 70, a lower end 72, and a central flow passage 74 extending therethrough. The upper end 70 is configured to mate with the fuel head body 12, typically as a corresponding male portion that engages the female portion 29 of the fuel head body 12. When the quick connect 34 is used, the body 64 of the adapter 50 includes a corresponding male connector portion, such as a cam groove 76, for engagement with the cam arms 34a of the quick connect 34.

The sealing assembly 66 includes a seal member 78, a support member 80, and a plurality of springs 82 configured to resiliently bias the seal member 78 against the fuel tank's filler tube 52. The springs 82 are housed in a series of bores 84 formed in the lower end 72 of the body 64, which are evenly spaced around the circumference. A distal end of each spring 82 engages the support member 80, which may be a rigid ring or plate.

The seal member 78 is mounted on the underside of the support member 80 and is an annular seal element or gasket. The seal member 78 may be constructed of a resilient compressible material, such as a polyurethane foam. This arrangement provides a fluid-tight seal between the adapter 50 and the upper end of the filler tube 52 when the adapter is installed. The spring-biased nature of the seal assembly 66 also permits the seal to be compressed for secure engagement and disengagement with the filler tube 52.

The locking pins 68, which may be roll pins, are housed within accommodating bores 86 provided in the interior of the lower end 72 of the body 64. In one arrangement, four locking pins are evenly distributed circumferentially.

The exposed end of each locking pin 68 is configured to interact with the lugs 58 on the filler tube 52. Specifically, the pin 68 engages the sloped surface 60 of the lug 58 during rotation of the adapter 50, guiding the adapter into place. Upon full rotation, the locking pin 68 seats within the notch 62 of the lug 58. This quick-closing mechanism requires only a small fraction of a turn to fully seat the adapter 50, providing a positive mechanical lock that resists accidental loosening and ensures a secure, leak-proof connection before fueling commences.

With the adapter 50 secured to the filler tube 52, the springs 82 are compressed, urging the seal member 78 against an upper end of the filler tube 52 to create a fluid-tight seal between the adapter 50 and the fill tube 54.

Although the presently disclosed inventive concepts have been described in conjunction with the specific language set forth herein, many alternatives, modifications, and variations will be apparent to those skilled in the art. Accordingly, it is intended to embrace all such alternatives, modifications, and variations that fall within the spirit and broad scope of the presently disclosed inventive concepts. Changes may be made in the construction and operation of the various components, elements, and assemblies described herein without departing from the spirit and scope of the presently disclosed inventive concepts.

What is claimed is:

1. An adapter for coupling a fuel delivery system to a fuel tank having a filler tube with an attachment feature, the apparatus comprising:
a body having an upper end, a lower end, and a flow passage extending therebetween, the upper end of the body configured to interface with a fuel head assembly;
a sealing assembly positioned at the lower end of the body, the sealing assembly comprising:
a resiliently compressible seal member having an annular shape and configured to contact an upper surface of the filler tube;
a support member supporting the seal member; and
a plurality of spring elements positioned within the body and biasing the support member and the seal member downwardly toward the filler tube; and
a locking mechanism positioned at the lower end of the body, the locking mechanism configured to detachably secure the body to the attachment feature of the filler tube with a partial rotation,
wherein, when the body is secured to the filler tube by the locking mechanism, the spring elements are compressed, causing the seal member to form a fluid-tight seal against the upper surface of the filler tube.

2. The adapter of claim 1, wherein the attachment feature of the filler tube comprises a plurality of circumferentially spaced lugs, each lug having a sloped surface and a locking notch, and wherein the locking mechanism includes a plurality of locking pins disposed about the interior of the lower end of the body, each locking pin configured to engage the sloped surface of one of the lugs during rotation and seat within the corresponding locking notch to secure the body to the filler tube.

3. The adapter of claim 2, wherein the seating of the locking pins in the locking notches provides a tactile indication of the fully secured position.

4. The adapter of claim 1, wherein the body includes a cam groove configured to receive cam arms of a quick-connect mechanism on the fuel head assembly.

5. The adapter of claim 1, wherein the resiliently compressible seal member is constructed of polyurethane foam.

6. The adapter of claim 1, wherein the plurality of spring elements are housed in a corresponding plurality of bores formed in the lower end of the body.

7. The adapter of claim 1, further comprising a flow passage through the body configured to receive an inlet tube extending from the fuel head assembly.

8. A fueling system for continuous refueling of equipment during hydraulic fracturing operations, the system comprising:
a fuel supply;
a fuel head assembly fluidly coupled to the fuel supply;
a fuel tank having a filler tube with a plurality of lugs defining a non-threaded inlet; and
a fuel head adapter interposed between the fuel head assembly and the filler tube, the fuel head adapter comprising:
a body defining a flow channel;
a spring-biased sealing assembly having an annular seal element; and
a quick-lock mechanism having a plurality of pins configured to engage the plurality of lugs upon a rotational movement,
wherein the spring-biased sealing assembly exerts a continuous downward sealing force against the filler tube when the pins are engaged with the lugs, thereby creating a fluid-tight connection.

9. The system of claim 8, further comprising a fuel level sensor operably associated with the fuel head assembly for monitoring the fuel level within the fuel tank.

10. A method for establishing a connection between a fuel delivery hose and a fuel tank inlet having an attachment feature, the method comprising the steps of:
coupling a fuel head adapter, the adapter having a spring-biased sealing member and a plurality of locking pins, to a fuel head assembly connected to the fuel delivery hose;
aligning the fuel head adapter with the fuel tank inlet such that the locking pins are positioned above the attachment feature;
applying a downward force to the fuel head adapter against the fuel tank inlet to partially compress the spring-biased sealing member against the inlet; and
rotating the fuel head adapter until the locking pins engage the attachment feature and seat into a locked position,
wherein seating the locking pins in the locked position compresses the spring-biased sealing member to form a fluid-tight seal between the adapter and the fuel tank inlet.

11. The method of claim 10, wherein the attachment feature comprises a plurality of lugs, and the locking pins seat into corresponding notches defined by the lugs.

12. The method of claim 10, further comprising the step of transmitting a signal from a fuel level sensor integrated into the fuel head assembly to a remote control center when the fuel reaches a predetermined level.
